(19) United States
(12) Patent Application Publication
(10) Pub. No.: US 2004/0179100 A1
(43) Pub. Date: Sep. 16, 2004

(54) Imaging device and a monitoring system

(75) Inventor: Masayuki Ueyama, Takarazuka-Shi (JP)

Correspondence Address: Kenneth L. Cage, Esquire, McDERMOTT, WILL & EMERY, 600 13th Street, N.W., WASHINGTON, DC, 20005-3096, US

(73) Assignee: MINOLTA CO., LTD.

(21) Appl. No.: 10/664,937

(22) Filed: Sep. 22, 2003

(30) Foreign Application Priority Data
Mar. 12, 2003 (JP) 2003-067119(PAT.)

(51) Int. Cl. H04N 7/18

(52) U.S. Cl. 348/152; 348/143

(57) ABSTRACT

Disclosed is a monitoring camera 2 and a monitoring system 1 including the camera 2 and a controller 3 which are interconnected with each other through a communication network. The camera is provided with a distortion lens for forming an image with the distortion being less and height of image is large in the central area of the image while the distortion being large and height of image is small in the peripheral area of the image. With that distortion lens, the camera forms a clear and large image of an object in the central area. The camera is switchable between a stand-by mode for outputting data of image of a wide area, and a close-observation mode for outputting data of the image of the central area extracted from the entire image. In the close-observation mode, the camera may track the movement of an object which intruded into the monitored area.

This application is based on patent application No. 2003-067119 filed in Japan, the contents of which are hereby incorporated by references.

### BACKGROUND OF THE INVENTION

1. Field of the Invention

The present invention relates to an imaging device such as a video camera and a monitoring system for detecting and pursuing an object intruded into a monitored area.

2. Related Art Statement

A monitoring system is known which uses a camera for continuously viewing an area or a scene to be guarded, secured or monitored (hereinafter referred to as a monitored are). It is desirable that an image of a particular object such as an intruder in the area is displayed and/or memorized in some detail. On the other hand, it is also desirable that a relatively large or wide area is monitored for the monitoring. When a picture of the area is taken through an objective lens having a relatively wide field of view, images of the objects in the area are small in size.

Japanese Unexamined Patent Publication No. 5-232208 discloses an electro-optical device for taking a picture of a monitored area through an optical system which forms an telephoto or magnified image in a central portion and distorted image in the peripheral area of the image formed by the objective lens to ensure wide field of view by the peripheral area. The device is arranged to track an object as an intruder such that the object is captured in the central portion view when the object appears in the field of view.

However, the prior art device as mentioned above displays an image distorted largely in the peripheral area so that the image to be displayed is inferior in visibility and gives a sense of incongruity to human vision.

Japanese Unexamined Patent Publication No. 2000-341568 discloses an image sensing device wherein an original image is formed on a CCD by a convex mirror called as a fovea mirror having an optical characteristic similar to a fovea of a human eye. The fovea mirror forms an image with telephoto effect in the central area of the image ensuring wide field of view by the peripheral area, with the image being distorted in the peripheral area. The prior art device applies pixel position conversion to image data of the original image to generate a panorama image with the distortion being corrected or removed.

However, in the second prior art device, the distortion of the image around the high-resolution image is corrected based on the high-resolution image so that an area ratio of the high-resolution image to the panorama image is relatively small. Thus, when the panorama image is displayed, for example, on a display, it is difficult to observe this object in detail even if a specific object is sensed with a high-resolution image.

Another prior art device is known which employs a fisheye lens to take a picture of an object, and which forms a part of the image formed by the fisheye lens, with the part being extracted from the entire image. However, it is difficult to observe a specific object in detail since the obtained image does not have a high resolution over the entire area.

### SUMMARY OF THE INVENTION

Accordingly, an object of the present invention is to provide an imaging device with which a specific object can be visually confirmed in a satisfactory manner.

Another object of the present invention is to provide an imaging device which provides image data representing an image of a specific object with a larger scale and good visibility.

Still another object of the present invention is to provide an imaging device which operates in a stand-by mode for providing image data of a wide area image, and in a close-observation mode for providing image of a central area image tracking a specified object to capture it in the central area. The central area image is obtained by extracting a central portion of an image formed by an optical system of the imaging device.

Further object of the present invention is to provide a monitoring system with which a specific object can be visually confirmed in a satisfactory manner.

Still further object of the present invention is to provide a monitoring system which displays an image of a specific object with a larger scale and good visibility.

Yet further object of the present invention is to provide a monitoring system which operates in a stand-by mode for displaying an image of a wide area of a monitored region, and in a close-observation mode for displaying a image of a central portion of the wide area image, tracking a specified object to capture it in the central area.

To attain one or more of the objects mentioned above, according an aspect of the present invention, an imaging device comprises an optical system having an optical characteristic that distortion is larger in a peripheral area than in a central area of the image formed by the optical system; an image data generating section for generating image data in a stand-by mode for waiting for intrusion of an object, and in a close-observation mode for taking a picture of the object while tracking the object; and a first image data processing section for generating, in the close-observation mode, a central image data representing an image of the central area, with the central image data being extracted from the image data generated by the image data generating section.

According to another aspect of the present invention, a monitoring system comprises a imaging device for generating image data representing an image of a central area of an image formed by an optical system, a controller including a display; and a communicating section for enabling communication between the imaging device and the controller, the display of the controller displaying the image of the central area when the central image data is transmitted from the imaging device to the controller through the communicating section. The optical system has an optical characteristic that distortion is larger in a peripheral area than in a central area of the image formed by the optical system. The imaging device includes an image data generating section for generating image data in a stand-by mode for waiting for intrusion of an object, and in a close-observation mode for taking a picture of the object while tracking the object; and a first image data processing section for generating, in the close-observation mode, a central image data representing an image of the central area, with the central image data being extracted from the image data generated by the image data generating section.

According to still another aspect of the present invention, a program product is to be read by a computer of a device for controlling an imaging device including an optical system having an optical characteristic that distortion is larger in a peripheral area than in a central area of the image formed by the optical system, and an image data generating section for generating data of the image formed by the optical system. The program product comprising instructions of taking a picture of a predetermined area and waiting for appearance of an specified object in a stand-by mode; and tracking and taking a picture of the specified object which appears in the predetermined area, extracting data of the image in the central area from the image data generated by the image data generating section.

These and other objects, features and advantages of the present invention will become more apparent upon reading the following detailed description along with the accompanying drawings.

### BRIEF DESCRIPTION OF THE DRAWINGS

FIG. 1 is a schematic illustration of a monitoring system according to an embodiment of the present invention,

FIG. 2 is a schematic illustration of a monitoring camera used in the monitoring system shown in FIG. 1,

FIGS. 3A and 3B are graphs showing characteristics of an objective lens used in the monitoring camera,

FIG. 4 is a diagram showing an example of an image obtained by photographing by the monitoring camera,

FIG. 5 is a block diagram of a control system of the monitoring camera,

FIG. 6 is a diagram for showing a method for storing an original image data in an image data memory,

FIG. 7 is a table showing addresses of storage areas of the image data memory and original image data stored at these addresses,

FIG. 8 is a diagram showing the addresses of the storage areas of the image data memory and image data of rearranged images to be stored at those addresses,

FIG. 9 shows a conversion table for a red image,

FIGS. 10A through 10D shows examples of rearranged images,

FIG. 11 is an explanatory diagram for showing a moving-object detecting operation,

FIGS. 12A and 12B are diagrams for showing a method for generating a conversion table,

FIGS. 13A, 13B and 13C are diagrams for showing the method for generating the conversion table,

FIG. 14 is a block diagram showing a control system of a controller,

FIG. 15 is a flow chart showing a monitoring operation in a standby mode,

FIGS. 16A and 16B are diagrams showing an operation of the monitoring camera when the monitoring camera is installed at a corner of a room to be monitored,

FIG. 17 is a flow chart showing a monitoring operation in a close-observation mode, and

FIGS. 18A and 18B are diagrams showing a background image used in a background image differentiation.

### DETAILED DESCRIPTION OF THE PREFERRED EMBODIMENTS OF THE INVENTION

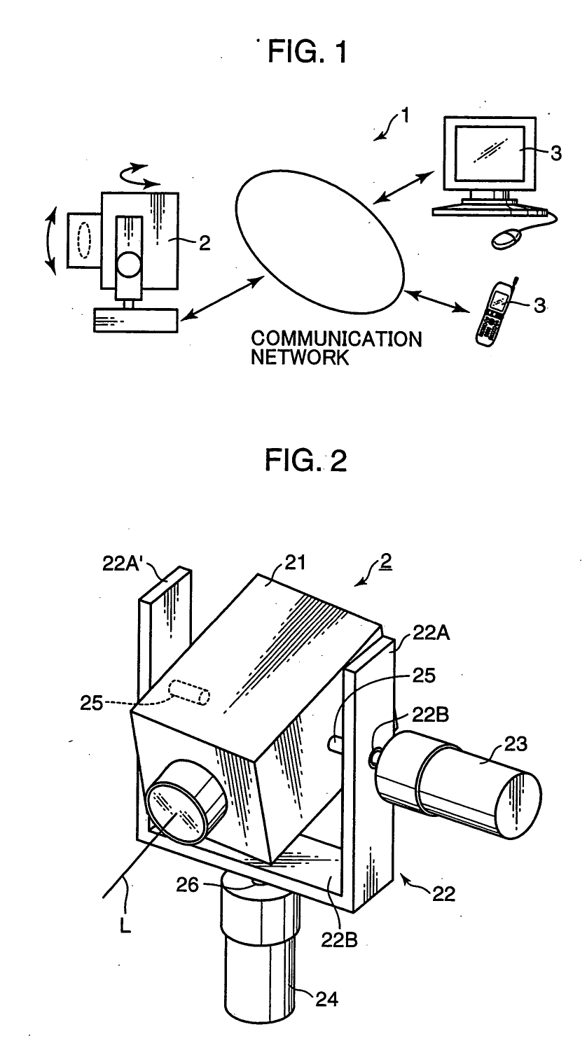

FIG. 1 is a schematic illustration of an arrangement of a monitoring system according to an embodiment of the present invention.

As shown in FIG. 1, the monitoring system 1 is composed of a monitoring camera 2 for capturing an image of a specified monitored area, a controller 3 such as a personal computer or a cellular phone, and a communication network for interconnecting the monitoring camera 2 and the controller.

In the monitoring system 1, when an image of the monitored area is captured by the monitoring camera 2, the obtained image data is transmitted from the monitoring camera 2 to the controller 3 via the communication network. On the other hand, when any request to the monitoring camera 2 is inputted in the controller 3, a signal representing this request (hereinafter, referred to as a request signal) is transmitted from the controller 3 via the communication network to the monitoring camera 2, which operates in response to the request signal.

The requests may include, for example, a request to establish a connection of the controller 3 with the monitoring camera 2 and a request to switch the image data to be transmitted from the monitoring camera 2.

With this arrangement, the image captured by the monitoring camera 2 can be visually observed on a display section 32 (see FIG. 14) of the controller 3, and the operation of the monitoring camera 2 can be remotely controlled.

The communication network for interconnecting the monitoring camera 2 and the controller 3 may be, for example, a radio or wireless LAN (local area network) built by the radio communication standards of Bluetooth (registered trademark) or using transmission medium such as radio waves or infrared rays or a LAN built by the standards of Ethernet (registered trademark).

FIG. 2 schematically illustrates the monitoring camera 2 used in the monitoring system 1.

As shown in FIG. 2, the monitoring camera 2 is composed of a camera body 21, a substantially U-shaped frame 22, a geared motor 23 for changing the viewing direction (direction of monitoring) of the camera 21 in vertical direction (hereinafter, referred to as tilting direction) and a geared motor 24 for changing the viewing direction of the camera 21 in horizontal or right-and-left direction (hereinafter, referred to as panning direction).

The camera body 21 is mounted on the U-shaped frame 22 with tilting direction rotational shafts 25 extending from the left and right surfaces of the camera body 21 and extending through holes 22B formed on side plates 22A and 22A′ of the U-shaped frame 22. An output shaft of the geared motor 23 is connected to the leading end of the rotational shaft 25 projecting through the side plate 22A. A panning direction rotational shaft 26 extends downward from the center of a bottom plate of the U-shaped frame 22, and an output shaft of the geared motor 24 is connected with the leading end of the rotational shaft 26.

The geared motor 23 is fixed to the frame 22 and so arranged to move in the panning direction together with the frame 22, whereas the geared motor 24 is fixed to a camera supporting structure(not shown).

In the above arrangement, when the geared motor 24 is driven, the U-shaped frame 22 is rotated about the rotational shaft 26, whereby the viewing direction of the camera 21 is changed in the panning direction. When the geared motor 23 is driven, the camera 21 is rotated about the rotatable shaft 25, whereby the viewing direction of the camera is changed in the tilting direction.

In the following description, a motion of the monitoring camera 2 in which the viewing direction of the camera 21 is changed in the panning direction is referred to as a panning motion, whereas that of the monitoring camera in which the viewing direction is moved in the tilting direction is referred to as a tilting motion.

In the monitoring camera 2, a wide-angle high-distortion lens system 201 (referred to as a distortion lens system hereinafter) having characteristics described below is adopted as an optical system for capturing an image of the monitored area.

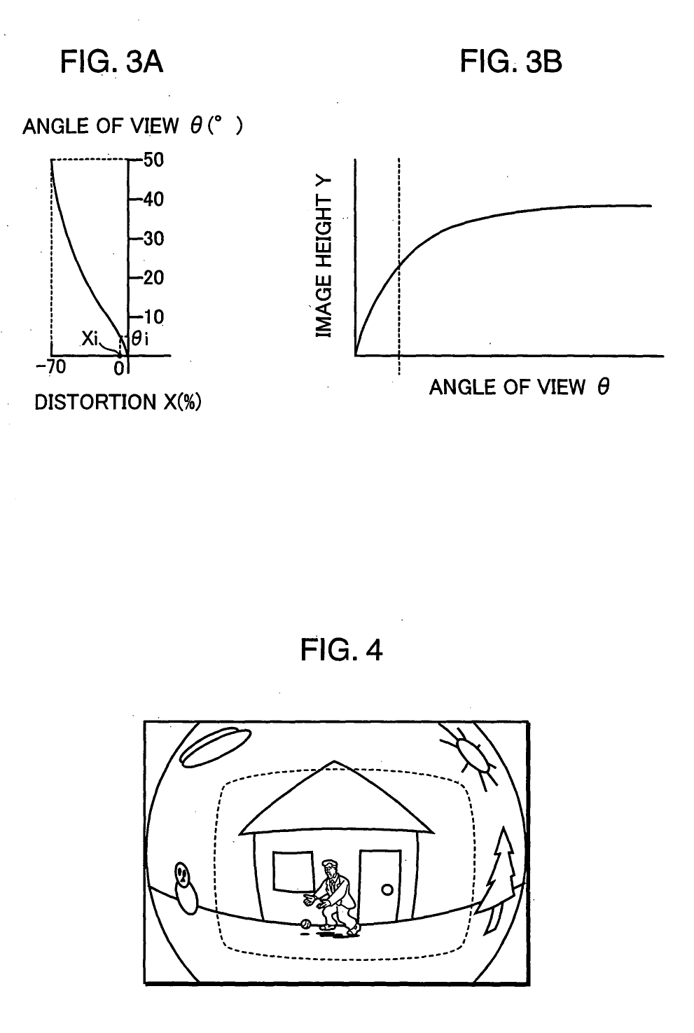

FIG. 3A is a graph showing a distortion vs. angle of view characteristic of the distortion lens system 201 wherein the abscissa represents distortion X in percent and the ordinate represents angle of view θ in degree (°). FIG. 3B is a graph showing an angle of view vs. height of image characteristic, wherein horizontal axis represents angle of view θ and vertical axis represents height of image Y.

As shown in FIG. 3A, the distortion lens system 201 has such a characteristic that the distortion X takes a specified value Xi or smaller in a region where the angle of view θ is small and suddenly increases when the angle of view θ exceeds such a region.

Here, the specified value Xi of the distortion X is such a value that an image with that value can be recognized by a person as natural and similar to the object without or with less distortion. Such an image is formed by light having passed through a central area of the distortion lens system 201. For example, Xi=about 3% (θi is about 8° at this time). Of course, even if the specified value Xi is set at a value below 3%, e.g. about 2% or about 1%, the above image is recognized by a person as a natural image free from distortion.

FIG. 3A shows the characteristic of the distortion lens system 201 having a distortion of about −70% at half the angle of view of about 50°.

By this characteristic, the height (hereinafter, “height of image”) Y of the image formed by the distortion lens system 201 has a substantially linear relation to the angle of view θ in the region where the angle of view θ is small (region at the left side of dotted line in FIG. 3B) and has a large rate of change in relation to a unit change of the angle of view θ. The height of image here means the height of an image formed by the lens, of an object with a given height and located at a given distance from the lens e.g. at 2m.

On the other hand, in a region where the angle of view θ is large (region at the right side of dotted line in FIG. 3B), the height of image Y has a nonlinear relation to the angle of view θ, has a gradually decreasing rate of change in relation to the unit change of the angle of view θ as the angle of view θ increases and eventually takes a substantially constant value.

In other words, resolution is high in the region where the angle of view θ is small, whereas it is low in the region where the angle of view θ is large.

By suitably setting a radius of curvature and other optical parameter of the distortion lens system 201, the distortion lens system 201 has a wider field of view as compared to a case where a normal lens is used instead of the distortion lens system 201 to obtain the same zooming ratio as is obtained in a central area (corresponding to the “region where the angle of view θ is small”) of the image where a large height of image Y can be obtained. At the same time, an image of an object can be formed in a large scale in the central area of the image as compared to a case where a normal lens is used instead of the distortion lens system 201 to obtain the same field of view as is obtained by the peripheral area (corresponding to the “region where the angle of view θ is large”) of the distortion lens system 201.

In this sense, the central area of the image formed by the distortion lens system 201 is referred to as a telephoto area and the peripheral area thereof is referred to as a wide-angle area in the following description.

In this embodiment, the distortion lens system 201 has a focal length “f” of 80 mm for the telephoto area, with the focal length being measured as being used for a 35 mm-camera and a focal length “f” of 16 mm for the wide-angle area, with the focal length being measured as being used for a 35 mm-camera. However, the distortion lens system 201 is not limited thereto.

The distortion lens system 201 has an optical characteristic similar to that of a human eye which has a highest visual power in the central portion of the retina called as a fovea centralis or central pit, with the visual power decreasing rapidly towards the periphery of the retina. In other words, the visual power of the human eye is highest at the central portion of the viewing field and decreases rapidly as the measured portion is away from the central portion. The distortion lens system 201 is designed to form an image with the largest height of image at the central portion of the image and with the height of the image being lower in the peripheral portion of the image. Accordingly, this type of distortion lens system 201 may be called as a fovea lens. The fovea lens is usually composed of a plurality of lens components which may include aspherical lens.

The fovea lens is a lens having a function of enlarging an image in the central area (corresponding to the telephoto area) of the field of view and compressing or contracting the image in the peripheral area (corresponding to the wide-angle area) and having a characteristic of providing natural images with inconspicuous distortions at a high resolution in the telephoto area while ensuring wide angle of view.

It should be noted that the normal lens mentioned above is such a lens that a relationship between its height of image Y, focal length “f” and angle of view θ is expressed by Y=f·tan θ.

When an image is captured using the distortion lens system 201 having the characteristic as described above, a captured image is such that objects in the peripheral area, i.e. in the wide-angle area is compressed by the distortion lens system 201, for example, as shown in FIG. 4, and an object or object in the central part i.e. in the telephoto area is enlarged as compared to the image of the wide angle area.

Accordingly, the monitoring camera 2 can take a picture of a wide area while the central part of the picture is taken with a high resolution. The image in the telephoto area enlarged by the distortion lens system 201 is referred to as a telephoto image.

The monitoring camera 2 of this embodiment has two operation modes taking advantage of the characteristic of the distortion lens system 201.

Specifically, since the distortion lens system 201 has a wide field of view as mentioned above, the monitoring camera 2 is operable in a standby mode and a close-observation mode. In the standby mode, the monitoring camera 2 monitors whether or not there is any moving object within the field of view, taking advantage of the wide view of the distortion lens system 201. When a moving object is detected in the standby mode, the camera 2 is switched to the close-observation mode wherein the monitoring camera 2 tracks the moving object while making the panning and tilting motions and takes picture of the moving object with a high resolution with the image of the tracked object being enlarged or magnified by the distortion lens system 201.

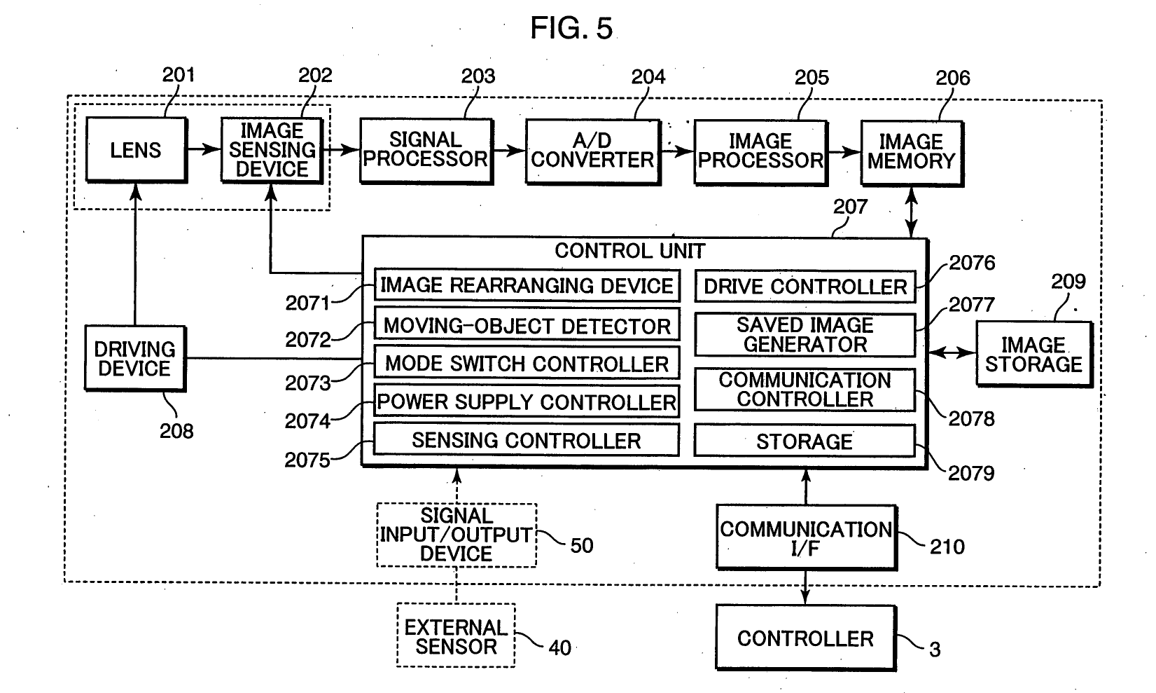

FIG. 5 is a block diagram showing the arrangement of the control system of the monitoring camera 2. The monitoring camera 2 is provided with the distortion lens system 201, an image sensing section 202, a signal processor 203, an analog-to-digital (A/D) converter 204, an image data processor 205, an image data memory 206, a control unit 207, a driving section 208, an image data storage 209 and a communication interface 210.

The lens section 201 includes an objective lens having the characteristic of the distortion lens system or fovea lens as described above for forming an image of an object scene to be monitored.

The image sensing section 202 is, for example, a CCD color area sensor in which a plurality of photoelectric conversion elements such as photodiodes are two-dimensionally arrayed in matrix, color filters of R (red), G (green) and B (blue) are arranged on light receiving surfaces of the respective photoelectric conversion elements at a ratio of 1:2:1. The image sensing section 202 photo-electrically converts an image of an object formed by the distortion lens system 201, into analog electrical signals (image signals) of the respective color components of R. G and B and outputs them as color image signals of R, G and B. It should be noted that the image sensing section 202 may be monochromatic instead of chromatic as mentioned above.

The start and end of an exposure of the image sensing section 202 and an image sensing operation including the readout of the output signals of the respective pixels of the image sensing section 202(horizontal synchronization, vertical synchronization, signal transfer) are controlled by a timing generator and the like (not shown but known per se).

The signal processor 203 applies a specified analog signal processing to the analog image signals outputted from the image sensing section 202, and includes a CDS (correlated double sampling) circuit and an AGC (auto-gain control) circuit, wherein the CDS circuit reduces noises in the image signal and the AGC circuit adjusts the level of the image signal.

The A/D converter 204 converts the analog image signals of R, G and B outputted from the signal processor 203, into digital image signals each of which is composed of a plurality of bits.

The image data processor 205 applies the following processes to the respective digital signals of R, G and B converted by the A/D converter 204: a black level correction for correcting a black level to a standard black level; a white balance for converting the levels of the digital signals of the respective color components R, G and B based on a white standard corresponding to a light source; and a gamma correction for correcting gamma characteristics of the digital signals of the respective color components R, G and B.

Hereinafter, the signal having processed by the image data processor 205 is referred to as an original image data. The pixel data of the respective pixels constituting the original image data are referred to as original pixel data. The image represented by the original image data is referred to as an original image. In this embodiment, the original image data of each color includes pixel data of 1280×1024 pixels.

The image data memory 206 is a memory adapted to temporarily store the image data outputted from the image data processor 205 and used as a work area for applying later-described process to this image data by the control unit 207.

Here, a method for storing the original image data in the image data memory 206 is described.

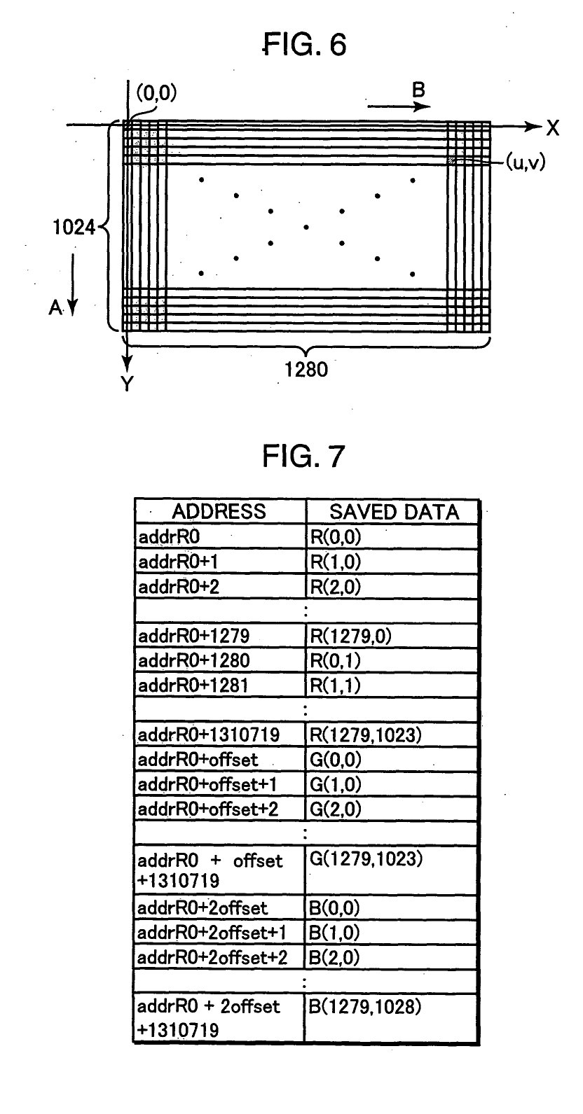

It is assumed that, of a storage area of the image data memory 206, storage areas of the original image data of R, G and B are virtually expressed in two-dimensional coordinate systems and the respective pixel data are arranged at grid points as shown in FIG. 6. It should be noted that only the two-dimensional coordinate systems for one color is shown in FIG. 6.

As shown in FIG. 6, the original pixel data of each color are successively stored in the image data memory 206 in a direction from the uppermost row to the bottommost row (direction of arrow A) and in a direction from left to right (direction of arrow B) in each row.

Specifically, it is assumed that addrR0 denotes an address where the pixel data of the pixel located at (0,0) is stored for the original pixel data of R, and that R(u, v), G(u, v), B(u, v) denote values of the pixel data of the pixels located at (u, v) (u=0 to 1279, v=0 to 1023) for three colors of the original image.

At this time, as shown in FIGS. 6 and 7, the original pixel data of R are successively stored such that R(1, 0) is stored at addr(R0+1), R(2, 0) at addr(R0+2), . . . , R(0, 1) at addr(R0+1280), and R(1279, 1023) at addr(R0+1310719) of the storage area of the image data memory 206.

This can be generally expressed as follows. If the original image of each color is assumed to have M pixels along X direction and N pixels along Y direction, the pixel data of the pixel located at (u, v) is stored at addr(R0+M×v+u) of the storage area of the image data memory 206 for the original image data of R.

Further, if it is assumed that addr(R0+offset) denotes an address where the pixel data of the pixel located at (0,0) is saved for the original pixel data of G, the original pixel data of G are successively stored such that G(1, 0) is stored at addr(R0+offset+1), G(2, 0) at addr(R0+offset+2), . . . , G(0, 1) at addr(R0+offset+1280), and G(1279, 1023) at addr(R0+offset+1310719) of the storage area of the image data memory 206 as shown in FIGS. 6 and 7 similar to the case of the image data of R.

The general expression of this is that the pixel data of the pixel located at (u, v) is stored at addr(R0+offset+M×v+u) of the storage area of the image data memory 206 for the original image data of G. “Offset” denotes the number of pixels constituting the original image of R or a larger integer and means that the original image data of G is saved after the storage area where the original image data of R is saved.

Similarly, if it is assumed that addr(R0+2×offset) denotes an address where the pixel data of the pixel located at (0,0) is stored for the original pixel data of B, the original pixel data of B are successively stored such that B(1, 0) is stored at addr(R0+2×offset+1), B(2, 0) at addr(R0+2×offset+2), . . . , B(0, 1) at addr(R0+2×offset+1280), and B(1279, 1023) at addr(R0+2×offset+1310719) of the storage area of the image data memory 206 as shown in FIGS. 6 and 7 similar to the case of the image data of R.

The general expression of this is that the pixel data of the pixel located at (u, v) is stored at addr(R0+2×offset+M×v+u) of the storage area of the image data memory 206 for the original image data of B.

The driving section 208 includes the geared motors 23 and 24 and changes the viewing direction of the monitoring camera 21 in panning direction and tilting direction in response to a command from the control unit 207.

The image data storage 209 includes a hard disk or the like and adapted to save an image file generated by a later-described saved image generator 2077 of the control unit 207.

The communication interface 210 is an interface based on the standards of the radio or wireless LAN, Bluetooth (registered trademark), Ethernet (registered trademark) and the like, and adapted to transmit the image data to the controller 3 and receive the request signal from the controller 3.

The control unit 207 is composed of a microcomputer having a built-in storage (storage 2079 to be described later) including, for example, a ROM for storing a control program and a RAM for temporarily storing data. The control unit 207 organically controls the driving of the respective members provided in the aforementioned camera body 21 and the camera system to generally control the image capturing operation of the monitoring camera 2.

The control unit 207 is provided, as functional blocks or units, with an image rearranging unit 2071, a moving-object detector 2072, a mode switch controller 2073, a power supply controller 2074, a sensing controller 2075, a drive controller 2076, the saved image generator 2077, a communication controller 2078 and the storage 2079.

Here, since the original image is generally distorted as described above, a distorted image is displayed on the display section 32 of the controller 3 if a data of the original image is transmitted to the controller 3 as it is. In that case, a satisfactory image visibility (natural looking of the image like as the scene and object are viewed by human eyes) cannot be obtained.

Further, since the original image data contains a relatively large amount of information or a volume of data, a communication of the image data between the monitoring camera 2 and the controller 3 takes much time and, therefore, the image display on the display section 32 of the controller 3 may not be synchronized with the image sensing operation of the image sensing section 202 performed, for example, every 1/30 seconds.

In order to solve such a problem, the image rearranging unit 2071 performs a process to correct the distortion created by capturing an image of the object using the distortion lens system 201 and generate a rearranged image whose number of pixels is smaller than that of the original image (hereinafter referred to as rearranging process). In this embodiment, the number of pixels of the rearranged image is 640×480.

The rearranging unit 2071 selects a suitable conversion table T corresponding to the operation mode (standby mode or close-observation mode) of the monitoring camera 2 from a plurality of later-described conversion tables T stored in the storage 2079 beforehand; extracts a part of the pixels of the original images using the selected conversion table T; arranges the extracted pixels to generate an image (rearranged image) by the extracted pixels; and stores image data of this rearranged image in a storage area of the image data memory 206 which is different from the area where the image data of the original image is saved.

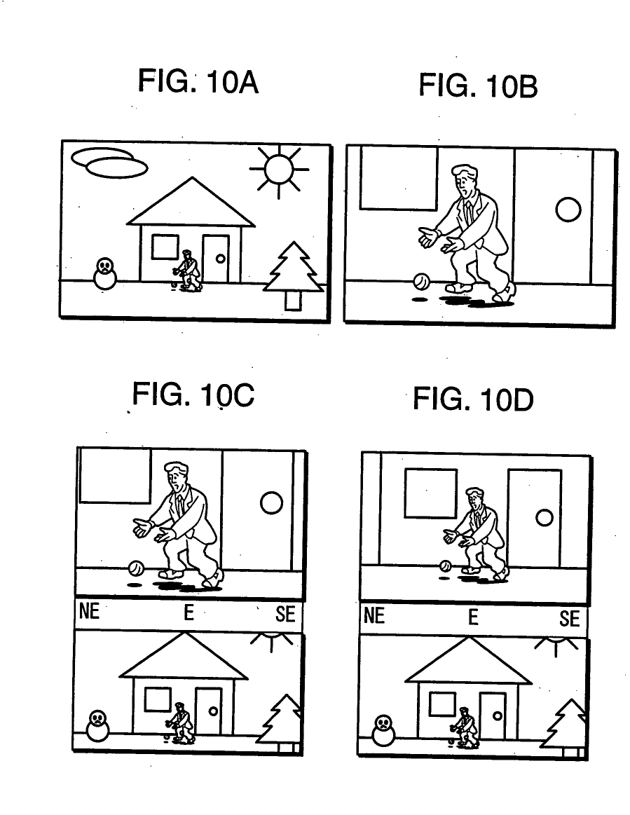

In the rearranging process, the pixels extracted from the original image in the standby mode are the pixels of a partial or entire image of the wide-angle area and the image of the telephoto area. On the other hand, the pixels extracted from the original image in the close-observation mode are the pixels of the telephoto area, generating an image shown in FIG. 10B as will be described later.

Here, upon describing the rearranging process, the respective storage areas for image data of R, G and B of the rearranged image in the storage areas of the image data memory 206 are virtually expressed in two-dimensional coordinate systems like as in the case shown in FIG. 6, and the rearranged image is generated by arranging the extracted pixels at the grid points of other two-dimensional coordinate systems.

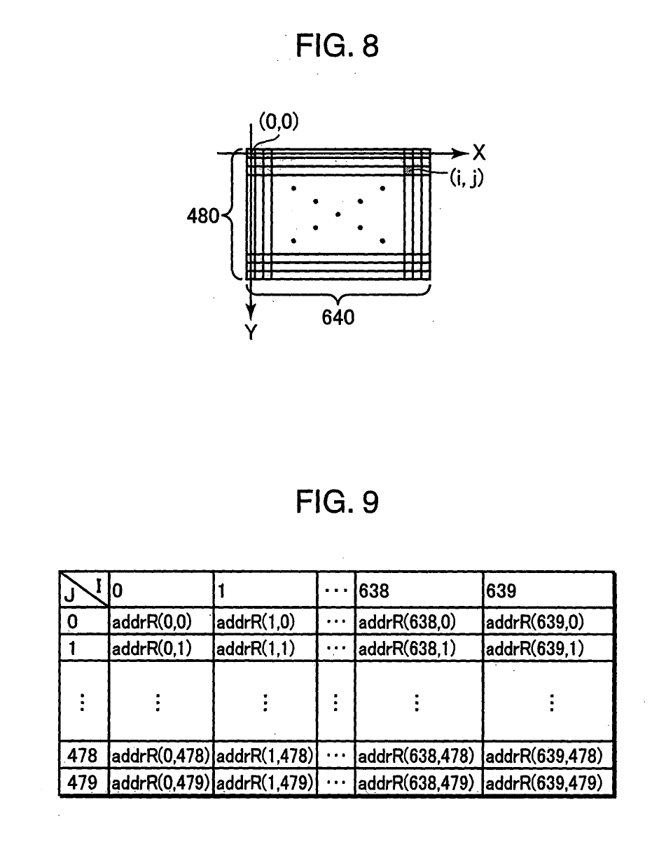

In order to distinguish the two-dimensional coordinate systems set for the rearranging process from those set for storing the original image, the former two-dimensional coordinate systems are referred to as rearrangement coordinate systems. It should be noted that only the two-dimensional coordinate systems for one color is shown in FIG. 8.

FIG. 9 shows the conversion table T for the image of R. As shown in FIG. 9, the conversion table T shows correspondence between the addresses of the pixel data of the original image data stored in the image data memory 206 and the respective coordinates (I, J) (I=0 to 639, J=0 to 479) of the rearrangement coordinate systems where the designated pixels are arranged or located.

In the conversion table T shown in FIG. 9, addrR(i, j) denotes an address where the original pixel data of R to be arranged at (i, j) in the rearrangement coordinate systems of R is stored. For example, of the pixels of the original pixel data of R, the pixel corresponding to the pixel data stored at addrR(0, 0) of the storage area of the image data memory 206 is arranged at (0, 0) in the rearrangement coordinate systems of R.

It is described above that, if the original image is assumed to have M pixels in X-direction and N pixels in Y-direction, the pixel data of the pixel located at (u, v) is saved, for example, at addr(R0+M×v+u) in the original image data of R. If the pixel located at (u, v) in the two-dimensional coordinate systems set for the original image is assumed to be arranged at (i, j) in the rearrangement coordinate systems, addrR(i, j) corresponds to addr(R0+M×v+u).

Similarly, if addrG(i, j) is assumed to denote an address where the original pixel data of G to be arranged at (i, j) in the rearrangement coordinate systems of G is stored. Of the pixels of the original pixel data of G, the pixel corresponding to the pixel data stored at addrG(i, j), i.e. addr(R0+offset+M×v+u) of the storage area of the image data memory 206 is arranged at (i, j) in the rearrangement coordinate systems of G.

Similarly, if addrB(i, j) is assumed to denote an address where the original pixel data of B to be arranged at (i, j) in the rearrangement coordinate systems of B is stored. Of the pixels of the original pixel data of B, the pixel corresponding to the pixel data saved at addrB(i, j), i.e. addr(R0+2×offset+M×v+u) of the storage area of the image data memory 206 is arranged at (i, j) in the rearrangement coordinate systems of B.

In this way, the conversion table T of this embodiment defines a method for extracting a part of the pixels from 1280×1024 pixels of the original image and arranging them at 640×480 grid points in the rearrangement coordinate systems for each color.

Accordingly, the rearranged image is generated in which the distortion created in the original image is corrected and the pixel number is reduced as compared to the original image, for example, rearranged image as shown in FIG. 10A is generated from the original image shown in FIG. 4.

As described above, a plurality of different conversion tables are prepared beforehand in this embodiment, and the image rearranging unit 2071 performs the rearranging process by selecting the conversion table T in accordance with the selected operation mode (standby mode or close-observation mode) of the monitoring camera 2, or in response to a command from the controller 3, or in accordance with other condition.

For example, in the standby mode, the image rearranging unit 2071 selects a conversion table T1 for generating a rearranged image from the data of the entire original image, the rearranged image showing a wide area, and generates a rearranged image showing a relatively wide area, for example, as shown in FIG. 10A, using this conversion table T1. Hereinafter, this rearranged image in the standby mode is referred to as a wide-angle image.

On the other hand, in the close-observation mode, the image rearranging unit 2071 extracts the image of the central area (image captured in the telephoto area) from the original image, selects a conversion table T2 for generating a rearranged image showing the image of the central area including a moving object, generates from the extracted pixel data such a rearranged image in which the moving object is enlarged as compared to the rearranged image generated in the standby mode as shown in FIG. 10B, using the conversion table T2. Hereinafter, this rearranged image in the close-observation mode is referred to as a close-observation image.

In this way, when the rearranged images generated in the respective operation modes are transmitted to the controller 3, an operator of the controller 3 can observe a wide area on the display section 32 in the standby position, whereas he or she can exactly and certainly observe the features of the moving object in the close-observation mode.

For the close-observation mode, other conversion tables T3 and T4 are also provided for showing two kinds of images at a same time as shown in FIGS. 10C and 10D.

The image rearranging unit 2071 generates one rearranged image in which reduced images of the respective rearranged images shown in FIGS. 10A and 10B are arranged one above the other with a specified interval therebetween as shown in FIG. 10C, using the conversion table T3, when the controller 3 designates the conversion table T3 as described later.

When it is judged that the moving object cannot be captured in the telephoto area by the monitoring camera 2, the image rearranging unit 2071 selects the conversion table T4 and generates one rearranged image in which a reduced image showing a more extended area including the moving object than in the image at the upper part of FIG. 1° C. and a part of the rearranged image shown in FIG. 10A are arranged one above the other with an interval therebetween.

In this way, the wide-angle image shown in FIG. 10A and the close-observation image shown in FIG. 10B are selectively displayed on the display section 32 (see FIG. 14) of the controller 3. Thus, switching operation for the display by means of an operating or manipulation section 31 is required for visually recognizing the two images. However, by simultaneously displaying two kinds of images as shown in FIGS. 10C and 10D, more secure monitoring can be conducted without requiring the user of the controller 3 to switch the display between the wide-angle image display and the close-observation image display by means of the manipulation section 31.

It should be noted that “SE” (south east), “E” (east), “NE” (north east) shown in FIGS. 10C and 10D denote directions in which the monitoring camera 2 views.

The moving-object detector 2072 detects an moving object in an original image by a time differentiation process described below.

The time differentiation is a process of determining differences between or among a plurality of images photographed at specified relatively short intervals and detecting an area having a change between or among the images (changed area).

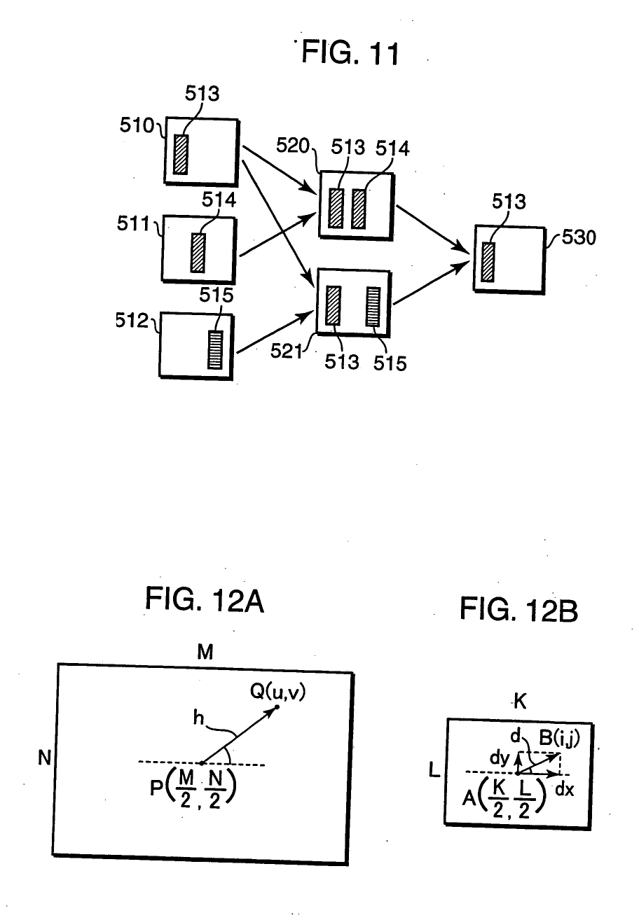

As shown in FIG. 11, the moving-object detector 2072 extracts a changed area using three images: a present image 510, an image 511 photographed a little earlier than the present image 510, and an image 512 photographed a little earlier than the image 511.

The image 510 includes an area 513 where a moving object is expressed. However, the area 513 expressing the moving object cannot be extracted from the image 510 only.

The image 511 includes an area 514 where the moving object is expressed. Although the same moving object is expressed in the areas 513 and 514, the positions thereof in the images 510 and 511 differ from each other since the images 510 and 511 of the moving object are photographed at different points of time.

A differentiated image 520 is obtained by differentiating the images 510 and 511. The differentiated image 520 includes the areas 513 and 514, with the image commonly existing in the images 510 and 511 being removed in the image 520 by the differentiation. The area 513 in the differentiated image 520 is an area expressing the moving object which was present at a position at the time when the image 510 was photographed. The area 514 in the differentiated image 520 is an area expressing the moving object which was present at a position at the time when the image 511 was photographed. A differentiated image 521 is obtained by differentiating the images 510 and 512, and includes the area 513 and an area 515, with the image commonly existing in the images 511 and 512 being removed in the image 521 by the differentiation. The area 513 in the differentiated image 521 is an area expressing the moving object, and is present at a position at the time when the image 510 was photographed. The area 515 in the differentiated image 521 is an area expressing the moving object which was present at a position at the time when the image 512 was captured.

Next, an image 530 is obtained by taking a logical multiplication of the differentiated images 520 and 521. As a result, the image 530 includes only the area 513 expressing the moving body at the time when the image 510 was captured. Thus, the moving body and its position is detected.

The mode switch controller 2073 switches the operation mode between the standby mode in which the monitoring camera 2 is fixed in a predetermined posture (initial posture) to capture an image of the entire monitored area and the close-observation mode in which the monitoring camera 2 is caused to track the moving object displaying the image of the telephoto area.

The mode switch controller 2073 switches the operation mode to the close-observation mode to monitor the features of the moving object in detail when the moving object is detected in the standby mode. The operation mode is switched to the standby mode to widely monitor the monitored area when the following close-observation mode ending conditions are satisfied in the close-observation mode.

In this embodiment, three close-observation ending conditions are provided for switching the operation mode from the close-observation mode to the standby mode:

(1) The moving object has moved out of the field of view,

(2) A specified period has passed after the moving object stopped within the view, and

(3) A specified period has passed after the operation mode was switched to the close-observation mode.

When any of the above conditions is satisfied, the operation mode is switched from the close-observation mode to the standby mode.

The close-observation ending conditions include the condition that the moving body has moved out of the field of view (condition (1)), when the moving object is thought to have left the monitored area.

The close-observation ending conditions include the condition that the specified period has passed after the moving object stopped within the field of view (condition (2)). In this condition, it is expected that the closely observed object will stop for a relatively long time as the motion of the closely observed object keep stopping for the specified period and other moving object(s) may be overlooked if such a closely observed object is persistently observed in the close-observation mode having a narrower field of view.

The close-observation ending conditions include the condition that the specified period has passed after the operation mode was switched to the close-observation mode (condition (3)) because other moving object(s) may be overlooked if such a closely observed object is persistently observed for a long time in the close-observation mode having a narrower view similar to the case of the condition (2), and the storage capacity of the image data storage 209 can be effectively used.

Upon receiving a request to establish a communication connection from the controller 3, the mode switch controller 2073 establishes the connection and then sets a remote-control mode for receiving various requests such as a request to change the posture of the monitoring camera 2. This remote-control mode is canceled if no request is made during a specified period.

The power supply controller 2074 controls on-off of the power supply of the monitoring camera 2 when a power switch (not shown) provided on the monitoring camera 2 is operated, and restricts a preliminary power supply to the driving section 208 such as the geared motors 23 and 24 and the communication interface 210 in the standby mode for energy saving.

The sensing controller 2075 causes the image sensing section 202 to sense images, for example, at intervals of 1/30 seconds in the standby mode while causing the image sensing section 202 to sense images at intervals shorter in close-observation mode than the intervals for the standby mode.

A time interval between the image sensing operations of the image sensing section 202 in the close-observation mode is set shorter than the one in the standby mode in order to carefully monitor the movement of the moving object. By setting the time interval between the image sensing operations of the image sensing section 202 in the standby mode relatively long, it can be prevented or suppressed that the close-observation image having a higher importance than the wide-angle image cannot be saved in the image data storage 209.

The drive controller 2076 controls the rotations of the geared motors 23 and 24 of the driving section 208. The drive controller 2076 stops the rotations of the geared motors 23 and 24 of the driving section 208 and fixes the monitoring camera 2 in the initial posture in the standby mode, whereas it drives the geared motors 23 and 24 to cause the monitoring camera 2 to track the moving object in the close-observation mode.

The saved image generator 2077 generates a compressed image data by applying a specified compression by the MPEG (moving picture experts group) method to the pixel data of the rearranged image, and saves an image file obtained by adding data of the photographed image (including metha data and compression rate) to the compressed image data.

In this embodiment, two kinds of compression rates are provided corresponding to the operation modes (standby mode and close-observation mode) of the monitoring camera 2, and the image is compressed at a relatively small compression rate in the close-observation mode so as to obtain information of detailed features of the moving object.

On the other hand, in the standby mode, the image is not required to have a high resolution so long as the moving object is detectable, and the image is compressed at a compression rate larger than the one used in the close-observation mode in order to save storage area of the image data storage 209 for the close-observation image having a higher importance than the wide-angle image.

The metha data is generally a data bearing information for identifying a subject data (e.g. data of the image captured by the monitoring camera 2 in this embodiment) which information is referred to retrieve the subject data from a multitude of data. A desired image can be easily retrieved from a plurality of images stored in the image data storage 209 by adding this metha data to the image data.

The communication controller 2078 establishes and breaks a communication connection of the monitoring camera 2 with the controller 3, and controls the transfer of the image data and the like from the image data memory 206 to the communication interface 210.

The storage 2079 includes a plurality of conversion tables T used by the image rearranging unit 2071 to generate rearranged images as described above. The conversion tables T are designed to determine beforehand how the pixel data of the pixels extracted from the original image are to be arranged in order to correct the distortion of the original image and to change the number of pixels and the size of the photographing area.

Hereinafter, a method for generating the conversion table T is described.

Assuming that the number of pixels of the original image is M×N as shown in FIG. 12A and the number of pixels of the rearranged image is K×L, coordinates (u, v) of a pixel Q of the original image corresponding to an arbitrarily selected pixel (hereinafter referred to as a referred pixel B, coordinates B(i, j)) of the rearranged image are calculated.

First, as shown in FIG. 12B, a distance d (dx: x-component, dy: y-component) from a center A (K/2, L/2) of the rearranged image to the referred pixel B is:

dx=(K/2−j) (1)

dy=(L/2−j) (2)

d=\sqrt{(dx²+dy²)} (3)

d=\sqrt{{(K/2−i)²+(L/2−j)²}} (4)

If it is assumed that the rearranged image shown in FIG. 12B is photographed using a normal lens whose relationship among the height of image Y, the focal length f and the angle of view θ is expressed by Y=f·tan θ, an angle of incidence φ of the light converted into the pixel data of the pixel located at the coordinate (i, j) in the rearranged image is the same as the angle of incidence of the light of the pixel data of the pixel located at the coordinate (u, v) in the original image.

Accordingly, if an angle of view of the rearranged image in horizontal plane is α radian, the angle of incidence φ of the light converted into the pixel data of the pixel located at the coordinate (i, j) in the rearranged image can be expressed as follows.

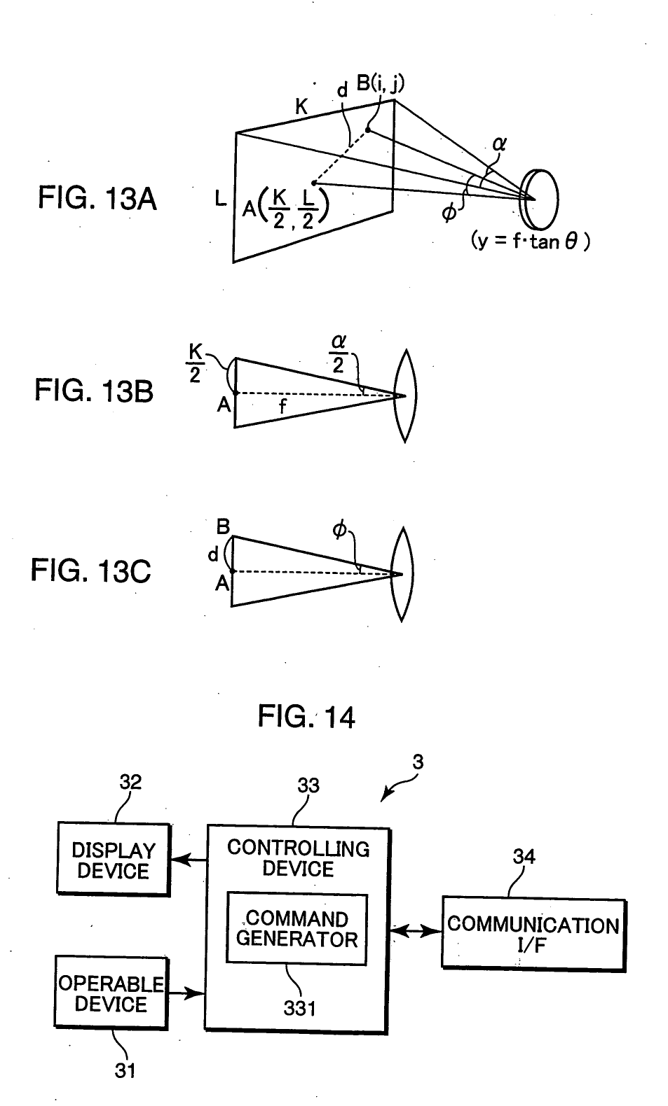

First, following two equations hold as can be seen from FIGS. 13A to 13C:

f=(K/2)/tan(α/2) (5)

tan φ=d/f (6)

Thus,

φ=tan¹{d/(k/2)/tan(α/2)} (7)

If h denotes a distance (height of image) between a center P (M/2, N/2) and the coordinates Q(u, v) in the original image, the distance h is expressed as a function of the angle of incidence φ calculated by equation (7).

h=f(φ) (8)

This function is determined according to a radius of curvature and other optical parameters of the distortion lens system 201.

On the other hand, following two equations hold as can be seen from FIGS. 12A and 12B.

h:d=(u−M/2):dx (9)

h:d=(v−N/2):dy (10).

From equations (9), (10), following equations (11), (12) are obtained.

u=M/2+h×(dx/d) (11)

v=N/2+h×(dy/d) (12)

In accordance with equations (8), (11) and (12), the coordinates (u, v) of the pixel data in the original image corresponding to the pixel data located at the coordinates (i, j) can be obtained.

The pixel data of the pixel located at the thus obtained coordinates (u, v) in the original image is stored at addr(R0+M×v+u) of the image data memory 206. When the rearranged image is generated by the image rearranging unit 2071 using the conversion table T (see FIG. 9), the pixel data at this address addr(R0+M×v+u) is arranged at addr(i, j) stored in the conversion table T.

On the other hand, the controller 3 includes the manipulation section 31, the display section 32, a controlling section 33 and a communication interface 34 as shown in FIG. 14.

The manipulation section 31 is adapted for inputting commands (hereinafter, “instruction commands”) to give the monitoring camera 2 various instructions such as making it to perform the panning and tilting motions, and the storing and transmission of the image data. The manipulation section 31 may take a form of a keyboard and a mouse in the case where the controller 3 is a personal computer (hereinafter, “PC”), whereas it may take a form of a set of push buttons in the case where the controller 3 is a cellular phone.

The display section 32 is adapted for displaying images due to the image data transmitted from the monitoring camera 2 via the communication network, and may take a form of a monitor in the case where the controller 3 is a PC while it may take a form of, for example, to a liquid crystal display in the case where the controller 3 is a cellular phone.

The controlling section 33 includes a microcomputer having built-in ROM 121 for storing, for example, a control program and RAM 122 for temporarily storing the data, and generally controls operation of the controller 3 by organically controlling the manipulation section 31, the display section 32, the communication interface 34, etc.

The controlling section 33 includes a command generator 331 which, upon the input of a specified instruction to the monitoring camera 2 from the manipulation section 31, generates an instruction command corresponding to the inputted instruction and sends the instruction command to the communication interface 34.

The instruction commands includes a command to request a communication process to establish a communication connection between the controller 3 and the monitoring camera 2, a command to instruct the panning motion and the tilting motion of the monitoring camera 2, a command to request the transmission of the image data stored in the image data storage 209 of the monitoring camera 2, a command to request a switching of image data to be transmitted in order to switch the image display mode on the display section 32, for example, between the one shown in FIG. 10B and the one shown in FIG. 10c, and a command to request the communication process to break the communication connection of the controller with the monitoring camera 2.

The communication interface 34 is an interface based on the standards of the radio LAN, Bluetooth (registered trademark), Ethernet (registered trademark), and the like, and adapted to receive the image data from the monitoring camera 2 and transmit the instruction commands to the monitoring camera 2.

Next, the monitoring operations by the monitoring camera 2 according to this embodiment are described. It should be noted that a remote control of the monitoring camera 2 from the controller 3 is assumed to be accepted only in the standby mode in order to simplify the following description.

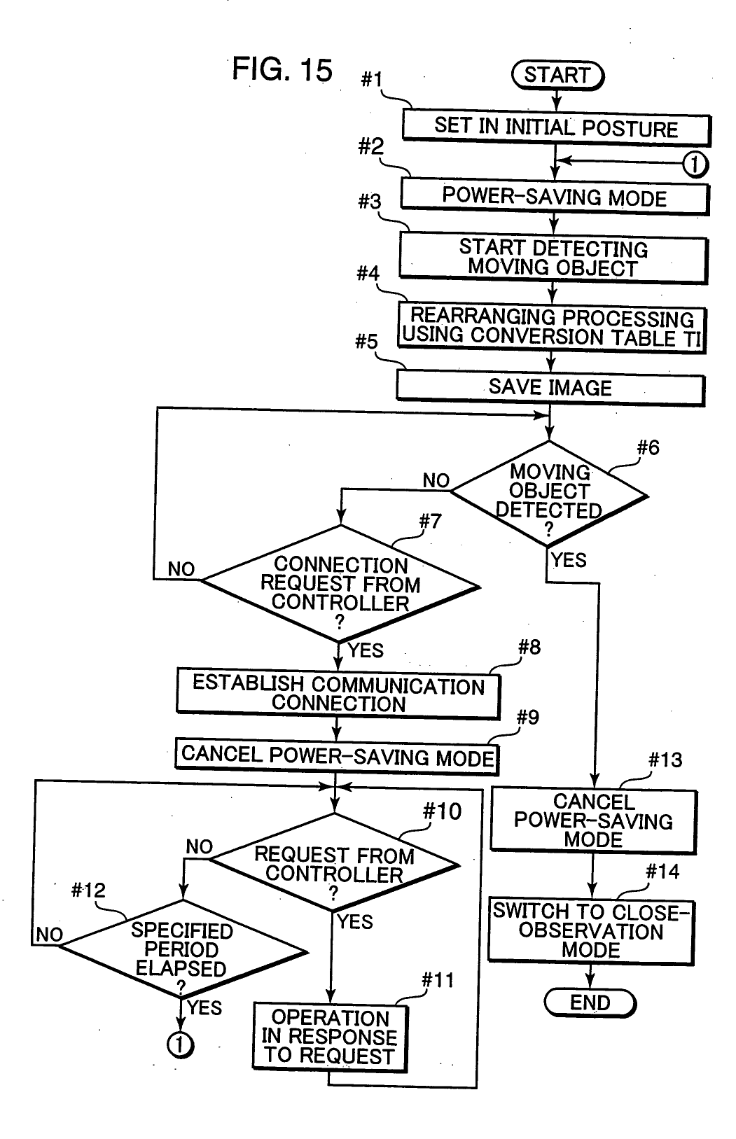

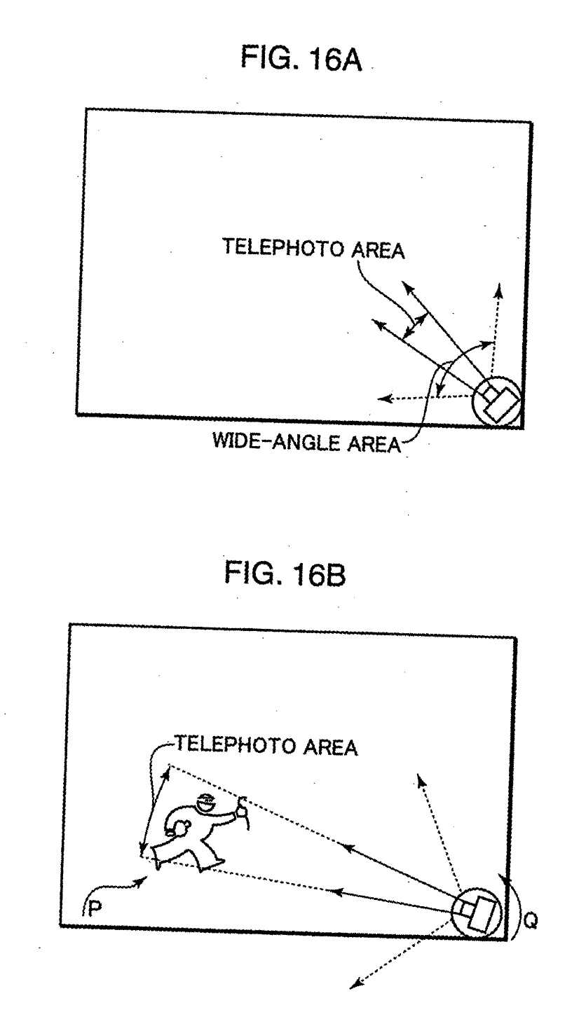

FIG. 15 is a flow chart showing a series of monitoring operations carried out in the standby mode, and FIG. 16 is a diagram showing the operation of the monitoring camera 2 in the case that the monitoring camera 2 is installed at a corner of a room to be monitored.

As shown in FIG. 15, the geared motors 23 and 24 are first controlled by the drive controller 2076 in the standby mode and the monitoring camera 2 is set in its initial posture where the entire area to be monitored is monitored as shown in FIG. 16A (Step #1).

Thereafter, a power-saving mode is set by the power supply controller 2074 in order to save energy, whereby power supply to the geared motors 23 and 24 and other components to be at rest is restricted (Step #2). Then, the detection of a moving object is started by the moving-object detector 2072 while an image data of an image photographed by the image sensing operation of the image sensing section 202 is stored in the image data storage 209 (Step #3).

A rearranged image showing a wide area, for example, as shown in FIG. 10A is generated using the conversion table T (Step #4) and stored in the image data storage 209 (Step #5).

When a signal for requesting the communication connection is received from the controller 3 via the communication interface 210 (YES at Step #7) before any moving object is detected (NO at Step #6), the communication connection of the monitoring camera 2 with the controller 3 is established by the communication controller 2078 (Step #8).

At this stage, the communication controller 2078 generates a reception signal representing that signal for requesting the communication connection has been received from the controller 3 and the communication interface 210 transmits the reception signal to the controller 3, thereby establishing the communication connection between the monitoring camera 2 and the controller 3.

Upon the establishment of the communication connection between the monitoring camera 2 and the controller 3, the remote-control mode for receiving the requests from the controller 3 is set after the power-saving mode is canceled by the power supply controller 2074 (Step #9).

In the remote-control mode, upon being requested from the controller 3 to perform, for example, the panning motion, the tilting motion, the transmission of the image data (YES at Step #10), the monitoring camera 2 operates in response to this request (Step #11).

Specifically, when the communication interface 210 receives a pan/tilt command, the panning motion and the tilting motion are conducted by the drive controller 2076 in response to this command. When a stored image transmission command is received, the image data stored in the image data storage 209 is transmitted by the communication controller 2078 and the communication interface 210 in response to this command.

When an image switching command is received, the image rearranging unit 2071 switches, in response to this command, the conversion table T to be used. When a connection end command is received, the communication connection between the monitoring camera 2 and the controller 3 is broken or cut off by the communication controller 2078 in response to this command. In this embodiment, since the conversion tables used to generate the rearranged images can be switched from one to another in the close-observation mode as described above, switching of the conversion table is made among or between the conversion tables for generating the rearranged image in the close-observation mode.

The process returns to Step #2 if no request has been made from the controller 3 even after the lapse of a specified period following the setting of the remote-control mode (NO at Step #10 and YES at Step #12).

The process returns to Step #6 unless the communication interface 210 receives the communication connection requesting signal from the controller 3 (NO at Step #7) before the moving object is detected (NO at Step #6).

When the moving object is detected by the moving-object detector 2072 (YES at Step #6), the operation mode of the monitoring camera 2 is switched to the close-observation mode by the mode switch controller 2073 (Step #14) after the power-saving mode is canceled by the power supply controller 2074 (Step #13).

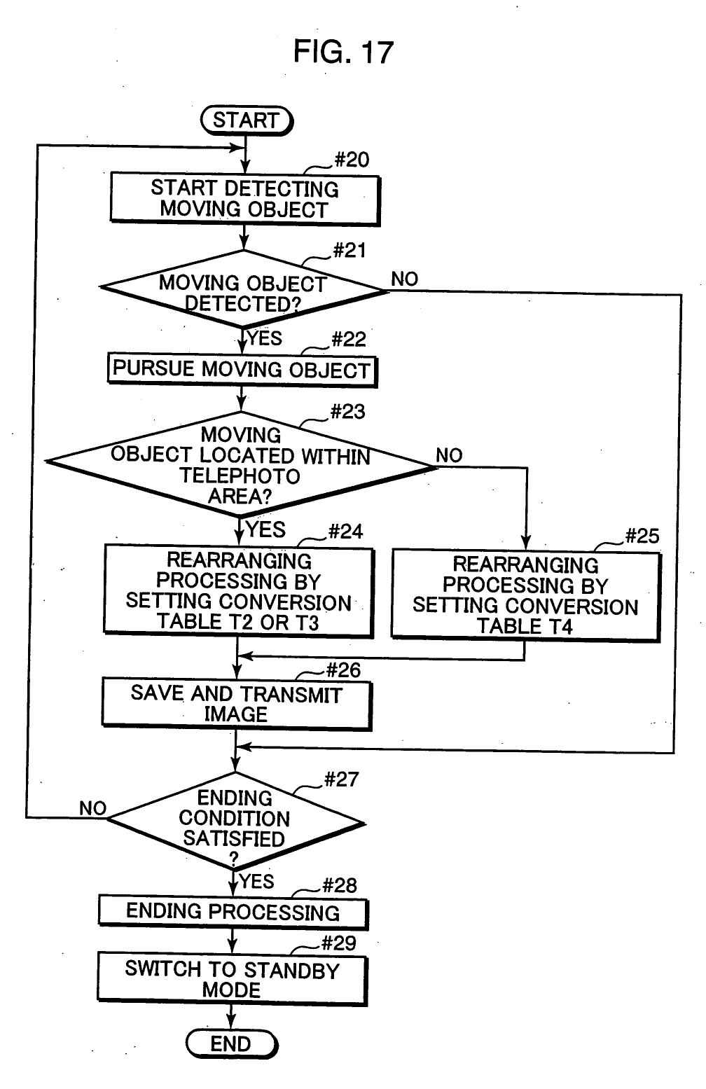

FIG. 17 is a flow chart showing a series of monitoring operations in the close-observation mode.

In the close-observation mode, the detection of a moving object by the moving-object detector 2072 is started while the image data of the image captured by the image sensing operation of the image sensing section 202 is being stored in the image data storage 209 (Step #20).

When a moving object is detected by the moving-object detector 2072 (YES at Step #21), the drive controller 2076 starts the operation control of the geared motors 23 and 24, i.e. the panning motion and the tilting motion of the monitoring camera 2 (Step #22).

For example, when a moving object appears in the monitored scene and moves as shown by an arrow P in FIG. 16B, the monitoring camera 2 is driven to change its viewing direction in a direction of an arrow Q from the initial viewing direction shown in FIG. 16A.

If the moving object is captured in the telephoto area by panning and tilting the monitoring camera 2 (YES at Step #23), a rearranged image showing the moving object in relatively large scale, for example, as shown in FIG. 10B or 10C is generated using the conversion table T2 or T3 (Step #24).

On the other hand, if the movement of the moving object is not tracked by the panning and tilting motions of the monitoring camera 2 and the moving object is not captured in the telephoto area (NO at Step #23), a rearranged image showing a more extended area including the moving object as shown in FIG. 10D as compared to the images shown in FIGS. 10B and 10C is generated by using the table T4 (Step #25).

The data of the rearranged image generated at Step #24 or #25 is stored in the image data storage 209 by the saved image generator 2077 and this image data is transmitted to the controller 3 via the communication controller 210 by the communication controller 2078 (Step #26).

Thereafter, the mode switch controller 2073 determines whether or not the close-observation mode ending condition is satisfied such as the exit of the moving object from the close-observation area or the lapse of the specified period after the operation mode of the monitoring camera 2 was switched to the close-observation mode (Step #27). The operations in Steps #20 through #26 are repeated while the close-observation mode ending condition is not satisfied (NO at Step #27).

On the other hand, if the close-observation ending condition is satisfied (YES at Step #27), the operation mode is switched to the standby mode by the mode switch controller 2073 (Step #29) after the monitoring camera 2 is reset to the initial posture by the drive controller 2076 and the driving section 208 (Step #28).

In this way, in the close-observation mode, the distortion lens system 201 is turned, with the image of the moving object being formed on the image sensing section 202 by the distortion lens system 201, and the rearranging process is carried out by extracting the pixels of the telephoto area portion of the original image which has a high resolution. Thus, the close-observation image showing the moving object in relatively large scale with no or little distortion can be obtained. As a result, an image with satisfactory visibility is displayed on the display section 32 of the controller 3.

In the standby mode as well, the rearranging process is carried out by extracting the pixels of the image in the telephoto area and a part or all of the peripheral or wide-angle area of the original image. Thus, a rearranged image showing a wider area as compared to the close-observation image and having no or little distortion can be obtained. As a result, the monitored area can be monitored by the controller 3 also in the standby mode.

Further, as a plurality of conversion patterns are provided with for the rearranging process, various close-observation images and various wide-angle images having different pixel numbers, different image display areas or different sizes of the image of the moving object can be obtained.

When the panning motion and the tilting motion of the monitoring camera 2 fails to follow the moving object in the close-observation mode, the monitoring camera 2 is switched to show the image of the wide-angle area in which the image of the moving object is expected to be included. The wide-angle area image is displayed singly as shown in FIG. 10A or along with the image of the telephoto area as shown in FIG. 10D. Thus, the features of the moving object can be monitored on the display section 32 of the controller 3 even if the moving object cannot be tracked by the panning motion and the tilting motion of the monitoring camera 2.

Further, since the operation mode is switched to the close-observation mode when the moving object is detected in the standby mode while the mode is switched to the standby mode when the close-observation mode ending condition is satisfied in the close-observation mode, the monitored area can be widely displayed in the standby mode until the moving object appears and the moving object can be monitored in detail in the close-observation mode when the moving object appears.

Since the metha data representing that the image is the close-observation image is attached to the image data of the close-observation image upon storing the image data of the close-observation image in the image data storage 209, a desired close-observation image can be easily retrieved from a plurality of close-observation images stored in the image data storage 209.

Further, since the image sensing section 202 is caused to perform the image sensing operations at shorter intervals in the close-observation mode than in the standby mode, more data of the moving object can be obtained in detail in the close-observation mode and it can be prevented or suppressed that the data of close-observation images having a higher importance than the data of the wide-angle images is not stored.

Furthermore, since the close-observation images are compressed at a lower compression ratio than the wide-angle images, the data of the moving object can be obtained in more detail in the close-observation mode than in the standby mode, and it can be prevented or suppressed that the data of close-observation images having a higher importance than the data of the wide-angle images is not stored.

Further, the controller 3 is provided with the command generator 331 for generating the instruction command to instruct the switching of the conversion tables, and the conversion table is switched in the monitoring camera 2 when the instruction command is transmitted from the controller 3 to the monitoring camera 2 via the communication interfaces 210 and 34 of the monitoring camera 2 and the controller 3. Thus, the conversion tables or the displayed images can be remotely switched by the controller 3.

Further, since the close-observation image and the wide-angle image are generated only by rearranging the pixels of the original image, it can be avoided to complicate the construction of the control unit 207.

The present invention is not limited to the foregoing embodiment but may be modified or varied in variously ways such as, by for example, described in the followings (1) through (13).

(1) The process for detecting the moving object is not limited to the aforementioned time differentiation. For example, a background image differentiation may be adopted in which a background area to be monitored may be specified beforehand, and an area not found in the background image is detected as a changing area based on a difference between a background image obtained by capturing an image of the background area beforehand and an image obtained by capturing an image of the present background area.

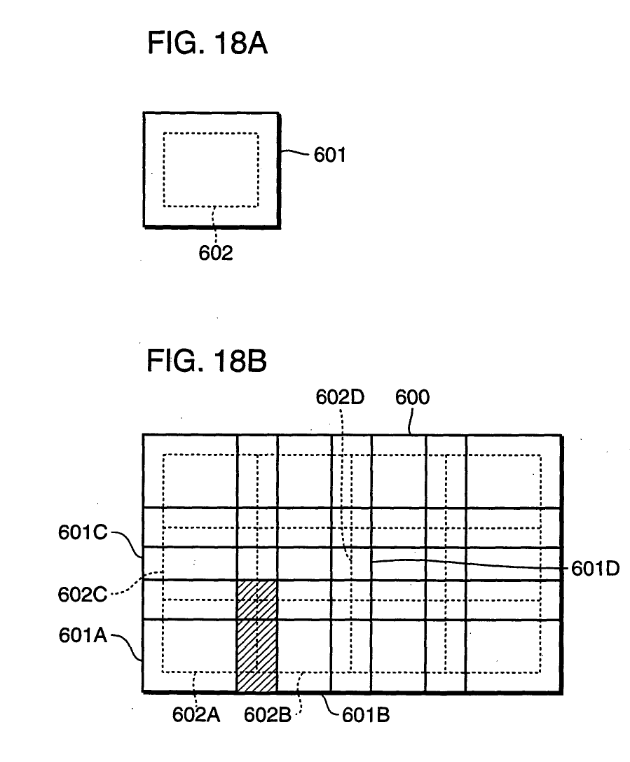

FIGS. 18A and 18B are diagrams for explaining a background image used in the background image differentiation, wherein FIG. 18A shows a background area and a presence permitted area, and FIG. 18B shows a relationship between the background area and an image capturing capable range of the camera.

As shown in FIG. 18A, a background area 601 is a range which can be monitored at a time by the camera 21 and includes a presence permitted area 602 which is an area specified beforehand in relation to the background image 601.

As shown in FIG. 18B, a plurality of background areas (rectangular areas delineated by solid lines) are arranged within the image capturing capable range 600 of the camera 21 such that adjoining background areas partly overlap each other. The presence permitted areas (the rectangular area delineated by broken lines) included in the background areas adjoin each other without overlapping with the presence permitted areas of adjoining background areas. For example, the background areas 601A and 601B overlap each other at the hatched portions, but the presence permitted areas 602A and 602B adjoin each other without overlapping each other.

By arranging the background areas and the presence permitted areas as mentioned above, a moving object within the image capturing capable range of the camera is present in any one of the presence permitted areas except a part of a peripheral area of the photographing capable range. Accordingly, the changing area can be tracked without any consideration of the moving direction or moving speed of the changing area or without predicting the position to which the changing area will move if the image capturing range of the camera is switched to the background area including the presence permitted area where the changing area is present.

Since the capturing capable range of the camera is divided into a plurality of sections to arrange a plurality of background areas with less overlapping, the capacity of saving the background image obtained by monitoring the background area can be reduce.

(2) Other processes may be adopted for detecting the moving object. For example, a color detection may be adopted in which a specific color, for example, a color of human skin is detected from an image and extracted therefrom.

(3) Although the rearranged image data is stored in the image data storage 209 built in the monitoring camera 2 in the aforementioned embodiment, the present invention is not limited thereto. For example, a computer (or a server) may store the rearranged image data in a case where the monitoring camera 2 is connected via a communication network with the computer for performing process, such as storage and provision of image data, in response to requests from a specified client unit including the controller 3.

(4) Although the image having 640×480 pixels is generated from the original image having 1280×1024 pixels by the rearranging process in the foregoing embodiment, the present invention is not limited thereto. For example, an image having 320×240 pixels may be generated.

(5) In the case where the monitoring system 1 includes a plurality of monitoring cameras 2, specific IDs (identifications) may be given to the respective monitoring cameras 2 and the IDs of the monitoring cameras 2 as communication partners are registered in the controller 3. When any of the monitoring cameras 2 is remotely controlled by the controller 3, various data including image data are transmitted and received after the ID of the selected monitoring camera 2 is designated by means of the manipulation section 31 of the controller 3 and a communication connection is established between this monitoring camera 2 and the controller 3.

(6) If the controller 3 is provided with a notifying device such as a light emitting device or a sound generator, the detection of the moving body may be notified to a user of the controller 3 by means of this notifying device.

(7) Although the image data is stored in the image data storage 209 not only in the close-observation mode but in the standby mode in the foregoing embodiment, the present invention is not limited thereto. The data of the image photographed in the standby mode may not be stored in the image data storage 209.

(8) An external sensor 40 for detecting, for example, that a window pane was broken, may be provided with to communicate with the monitoring camera 2 as shown in FIG. 5. In that case, the monitoring camera 2 may start monitoring upon the receipt of a detection signal from the external sensor 40.

In more detail, the monitoring camera 2 may be provided with a signal input/output device 50 to receive the detection signal from the external sensor 40 and output a switch control signal to turn on and off the power supply to the external sensor 4 by means of this signal input/output device 50. If an external equipment other than the external sensor 40 is connected with the monitoring camera 2 for communication, various signals including the above switch control signal may be transmitted and received between the external equipment and the monitoring camera 2.

(9) If the monitoring camera 2 is provided with a device (not shown in the Figures) for reading and writing data in and from an external storage medium, such as a flexible disk, a CD-ROM or a DVD-ROM, a storage medium may be provided with for storing a program for causing the monitoring camera 2 to function as the image rearranging unit 2071, the moving-object detector 2072, the mode switch controller 2073, the power supply controller 2074, the sensing controller 2075, the drive controller 2076, the saved image generator 2077, the communication controller 2078 and the storage 2079, and the program is installed in the monitoring camera 2 such that the monitoring camera 2 may be provided with the functions of the image rearranging unit 2071 and the other functional blocks and units.

(10) Although the moving object is detected from the original image in the foregoing embodiment, the present invention is not limited thereto. A wide-angle image as shown in FIG. 10A may be generated also in the close-observation mode and a moving object may be detected from this wide-angle image.

(11) Although the viewing direction of the camera 21 is changed in the panning direction and the tilting direction in the foregoing embodiment, the present invention is not limited thereto. The viewing direction of the camera 21 may be changed in parallel or translated by moving the camera 21 along a plurality of axes which intersect with each other.

(12) An image magnified more than the close-observation image may be generated by applying digital zooming to the close-observation image, and this magnified image may be displayed on the display section 32 of the controller 3.

In this case, the digitally zoomed image has a slightly lower resolution when being displayed. However, since the close-observation image has a high resolution, the image having a relatively high resolution can be obtained even if digital zooming is applied at a relatively large zooming ratio.

(13) In the close-observation mode, the rearranging process is carried out by extracting the pixels of the telephoto area portion of the original image which has a high resolution. Instead thereof, the image for the close-observation mode may be extracted by restricting the photo-electrically converted area on the image sensing section 202 by means of the a sensing controller 2075.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An imaging device comprising
a wide-angle high distortion optical system having an optical characteristic that an image of an object is projected in larger magnification in the central area of the image than in a peripheral area and that distortion is larger in the peripheral area than in a central area of the image formed by the optical system;
an image capturing section for capturing the image data formed by the optical system in a stand-by mode for waiting for intrusion of an object, and in a close-observation mode for taking a picture of the object while tracking the object; and
an image data generating section for generating, in the close-observation mode, a central image data representing an image of the central area of the image projected on the image capturing section by the optical system.

2. An imaging device according to claim 1 wherein, in the stand-by mode, the image data generating section extracts the central image data and an image data representing at least a part of the image in the peripheral area such that an image of a wide area is formed.

3. An imaging device according to claim 2 wherein the image data generating section generates an image data representing a compound image wherein the central area image and the wide area image are compounded.

4. An imaging device according to claim 2 further comprising an image data processing section for processing the central image data such that the central image is displayed in an enlarged form and processing the wide area image data such that the wide area image is displayed with less distortion.

5. An imaging device according to claim 1 further comprising a memory for storing the central image data generated by the image data generating section.

6. An imaging device according to claim 5 wherein the image capturing section includes two-dimensionally arranged pixels, the memory stores data of a plurality of pixel position conversion patterns, and the image data generating section selects data of one of the pixel position conversion patterns and generates the image data using the selected pixel position conversion pattern.

7. An imaging device according to claim 5 further comprising an identifying data adding section for adding, to the central image data, an identifying data for identify the central image data to be stored in the memory.

8. An imaging device according to claim 1 further comprising a control section for switching an operation mode of the imaging device between the stand-by mode and the close-observation mode.

9. An imaging device according to claim 8 further comprising an object detecting section for detecting a specified object based on the image data captured by the image data capturing section in the stand-by mode, and wherein the control section switches the operation mode of the imaging device to the close-observation mode when the object detecting section detects the specified object.

10. An imaging device according to claim 8, wherein the control section switches the operation mode of the imaging device to the stand-by mode when a predetermined ending condition is satisfied in the close-observation mode.

11. An imaging device according to claim 8, wherein the control section control the image capturing section to generate the image data at intervals shorter in the close-observation mode than in the stand-by mode.

12. An imaging device according to claim 1 further comprising a communication section for communicating with an external device, and a communication control section for transmitting the central image data to the external device through the communication section.

13. A monitoring system comprising;
a imaging device including
a wide-angle high distortion optical system having an optical characteristic that an image of an object is projected in larger magnification in the central area of the image than in a peripheral area and that distortion is larger in the peripheral area than in a central area of the image formed by the optical system;
an image capturing section for capturing the image data formed by the optical system in a stand-by mode for waiting for intrusion of an object, and in a close-observation mode for taking a picture of the object while tracking the object; and
a first image data generating section for generating, in the close-observation mode, a central image data representing an image of the central area of the image projected on the image capturing section by the optical system;
a controller including a display; and
a communicating section for enabling communication between the imaging device and the controller, the display of the controller displaying the image of the central area when the central image data is transmitted from the imaging device to the controller through the communicating section.

14. A monitoring system according to claim 13 wherein the image data generating section includes two-dimensionally arranged pixels, and the image data processing section generates the central image data using a predetermined pixel position conversion pattern.

15. A monitoring system according to claim 13 wherein the imaging device further includes a memory for storing data of a plurality of pixel position conversion patterns and the controller transmits, through the communicating section to the imaging device, a signal for instructing the imaging device to switch the pixel position conversion pattern.

16. A program product to be read by a computer of a device for controlling an imaging device including a wide-angle high distortion optical system having an optical characteristic that an image of an object is projected in larger magnification in the central area of the image than in a peripheral area and that distortion is larger in the peripheral area than in a central area of the image formed by the optical system; and image capturing section for capturing the image formed by the optical system, the program product comprising instructions of:
taking a picture of a predetermined area and waiting for appearance of an specified object in a stand-by mode; and
tracking and taking a picture of the specified object which appears in the predetermined area, generating a central image data representing an image of the central area of the image projected on the image capturing section by the optical system.

17. A program product according to claim 16 further comprising an instruction of extracting the central image data and an image data representing at least a part of the image in the peripheral area in the stand-by mode such that an image of a wide area is formed.

18. A program product according to claim 16 further comprising instructions of detecting a specified object based on the image data generated by the image data generating section in the stand-by mode, and switching the operation mode of the imaging device to the close-observation mode when the specified object is detected.

19. A program product according to claim 15 further comprising an instructions of switching the operation mode of the imaging device to the stand-by mode when a predetermined ending condition is satisfied in the close-observation mode.

20. A program product according to claim 15 further comprising an instructions of transmitting data of the image of the central area to a display device connected with the imaging device, and causing the display device to display the image of the central area.

21. an imaging device comprising:
a wide-angle high distortion optical system having an optical characteristic that an image of an object is projected in larger magnification in the central area of the image than in a peripheral area and that distortion is larger in the peripheral area than in a central area of the image formed by the optical system;
an image capturing section for capturing the image data formed by the optical system;
an operation mode control section for controlling the imaging device to operate in a stand-by mode wherein the imaging device monitors relatively wide area of a scene to be monitored and operate in a close-observation mode wherein the imaging device monitors an object while tracking the object, and
an image data generating section for generating, in the close-observation mode, a central image data representing an image of the central area of the image projected on the image capturing section by the optical system.
